(19) United States
(12) Patent Application Publication
(10) Pub. No.: US 2008/0229235 A1
(43) Pub. Date: Sep. 18, 2008

(54) VARIABLE-SPEED BROWSING METHOD FOR DIGITAL IMAGES

(76) Inventors: Jean-Marie Vau, Paris (FR); Thierry Lebihen, Bourg La Reine (FR); Christophe E. Papin, Bois Colombes (FR); Eric Masera, Paris (FR)

Correspondence Address: David A. Novais;Patent Legal Staff, Eastman Kodak Company, 343 State Street, Rochester, NY, 14650-2201, US

(21) Appl. No.: 12/045,770

(22) Filed: Mar. 11, 2008

(30) Foreign Application Priority Data
Mar. 12, 2007 (FR) 0701749

(51) Int. Cl. G06F 3/048

(52) U.S. Cl. 715/784

(57) ABSTRACT

Method for browsing within a set of images (100) including images (102) that have been indexed with at least one indexation value taken from at least one measurement scale, with the method including a display that scrolls through the images in a set of images in which at least one display parameter for each image is a non-constant function of at least one indexation value for the image.

### CROSS REFERENCE TO RELATED APPLICATION

Reference is made to and priority claimed from French Application Serial No. 0701749 filed Mar. 12, 2007.

### FIELD OF THE INVENTION

The present invention relates to a method of browsing within a set of digital images. Browsing means reviewing a certain number of images, possibly in an empirical manner, as a means of searching for one or more individual images.

Browsing for digital images would, in a sense, be the equivalent of a traditional rummage through a shoe-box for conventional camera film-based photographs. More generally, the term browsing is used to differentiate from searches performed using an address, an identifier or a cursor to automatically access the image or image data being looked for.

### BACKGROUND OF THE INVENTION

Browsing within a set of digital images implies not only the display of a certain number of images, but also the factoring in of one or more user commands that can influence the way the images are skimmed through.

To illustrate this point, browsing comprises simultaneously or successively displaying all the images in a selected set of images so that they can be skimmed through visually. Simultaneous display is generally only used on devices with a large screen. When the size of the display screen used for browsing is too small or the number of images to be browsed is too big, it is generally the successive run-through option that is used. The display can also be done via successive pages of images, each page simultaneously displaying a number of images. If the simultaneous image display format is chosen, a user-friendly control interface is employed to enable a cursor to browse over a multitude of displayed images. When the images are displayed successively, a cursor can also be employed to control the display sequence, and possibly also to change the speed at which the sequence is skimmed through.

For illustrative purposes, U.S. Publication No. 2005/0207733 gives an example of variable-speed browsing within a set of video images. The use of a cursor is proposed in U.S. Pat. No. 6,915,489.

Browsing techniques all offer a certain level of user-friendliness when the number of images to be browsed remains manageable. However, as the number of images increases, browsing tends to become increasingly tedious. At this point, it is possible, as proposed in U.S. Pat. No. 7,130,864, to limit browsing to subsets of digital images that are classed by theme, or by time, or that are more generally associated with a type of metrics system able to pre-sort the selection.

Other conventional techniques, propose sorting methods, display methods, and more generally data, document and (or) image management solutions designed to make them easier to search for.

Regardless of the sorting or pre-selection techniques employed, browsing remains an essential part of searching for an image about which the user has only an intuitive notion or a vague memory. According, improved techniques are still needed.

### SUMMARY OF THE INVENTION

An object of the invention is to make intuitive browsing easier, not only in terms of the successive display of images but also in terms of how this display is controlled.

Another object of the invention is to propose a browsing method tailored to searches performed in particularly large sets of images, for which conventional scroll-through would be tedious and only very randomly efficient.

It is another object of the invention to propose a browsing method tailored to any kind of multimedia hardware, and in particular mobile hardware such as pocket multimedia platforms, that have a relatively small display screen.

To achieve these objects, the invention proposes, among other things, a method for browsing within a set of digital images comprising images that have each been indexed with at least one indexation value taken from at least one measurement scale, with the method comprising a display that scrolls through the images in a set of images in which at least one display parameter for each image is a non-constant function of at least one indexation value for the image.

Digital images means a set of digital data of which at least one part is capable of being employed to produce a display on a screen. A digital image is therefore a dataset that can include a first body of data corresponding to a digital photograph or a graphics representation that are capable of being displayed, and a second body of data that is not necessarily displayable. This is, for example, information or meta-data included in the image. This may also be the above-mentioned indexation values. By extension, and since the method according to the invention is primarily designed for photographs, the word image also means the photograph that the digital image represents.

The indexations values used according to embodiments of the invention are values taken from one or more measurement scales and that are associated with the images. The indexation values are considered as being taken from a measurement scale if these values can be used to establish a ranking within the set of images, or when they are capable of being compared with one another.

An example of a very common measurement scale is the time scale. In this case, the indexation values can include the date and (or) time that the image data was created. This is, for example, the date of image capture that is automatically associated with pictures taken by a digital camera. When the image capture device is fitted with a geolocation system, such as a ‘GPS’ system for example, the indexation values can also geographical positions taken, for example, on a scale of latitude or longitude, or a distance in relation to a geographical site.

When the set of images has gone through any kind of editing and assessment in terms of an intrinsic property of the image or of an object that it represents, then the assessment values can also act as indexation values.

Generally speaking, measurement scales can be time scales, distance scales, spatial coordinates or scales of quantity of the information within the images themselves or within the measurement scales characterizing the image. The measurement of the quantity of information within the image can include, for example, the number of predefined objects or faces in the image. The measurement of the image characteristics can include colorimetrics, spatial data distribution, number of spectral channels, luminosity, etc., or even any subjective scale of image assessment.

The measurement scale can also be a scale of image quality, for example in terms of sharpness or contrast, a scale defining the number of times the image has been edited, a scale defining the number of images associated with a given image, or, a scale defining the number of times the image has been used in photo composition products.

Finally, the measurement scale can be a measurement scale of local or global image texture.

The texture measurement makes it possible to attribute indexation values to the images based on how uniform their content is. The texture measurement can also be a measurement of the quantity of oriented structures in the image. For example, the measurement of the quantity of vertical structures can prove useful when searching for images of trees or forests, or possibly for architectural features.

The same image within a set of images can be associated with different indexation values taken on different scales.

As mentioned above, browsing covers a scrolling display of the images in which a display parameter for each image can be expressed as a non-constant function of at least one indexation value.

An image display parameter can, for example, be a relative duration of image display during the scroll-through. Other potential image display parameters can be an image size, a presentation format, a display, a color saturation, or more generally, any parameter capable of being expressed as a function of one or more image indexation values. Display presentation format includes effects such as blur or sharpness enhancement, slant, frame, a 3D presentation format, or an image animation that can draw the user's attention specifically to certain images.

A result of this variability in display according to display values is that the scroll-through is no longer uniform, which consequently serves to highlight certain images.

It should be noted that the fact of having display parameters, and particularly the on-screen display duration of each image, depend on indexation values does not rule out the possibility of having the on-screen display duration also depend on other parameters that are not themselves indexation values. For example, the on-screen display duration of each image can also depend on a scroll-through speed that is set by the user. In this scenario, the indexation value essentially has the effect of modulating this speed.

Browsing can also be improved by selecting at least one setpoint indexation value. In this scenario, the display duration or the display parameter for each image can be a function of not simply the indexation value but of at least a deviation between an image indexation value and the setpoint value, said deviation being measured, on at least one common measurement scale, between the setpoint value and the indexation value.

The setpoint value can be a value entered by the user by means of an input interface, or it can be determined as a user-selected setpoint image indexation value.

A simple illustration of this point is that, for time-indexed images, it is possible to establish that the on-screen image display duration is a decreasing function of a time-based deviation between a date entered by the user and the date of each image in the set of images to be browsed through. The user may, for example, remember a photograph taken on a birthday. In this scenario, the setpoint value the user will enter is the date of this birthday. As the images in the set of images are scrolled on screen, it is true that all the images are displayed, but the closer the capture date of the images is to the birthday date entered, the longer those images are displayed on screen.

Another example can be given for spatial indexation. The user selects a setpoint image which is not the image they are looking for but which is an image that corresponds to a photographed place that is geographically very close to the place in the image the user is searching for. The image searched for is, for example, a photograph that the user cannot date with any precision but that they associate with a journey in a certain country or to a certain town. The user thus selects another image that is not the image they are searching for but that they know was taken in the same country or the same town. This image is the setpoint image.

The spatial image capture coordinates of the setpoint image selected are therefore established as a setpoint cue, and a geographical distance is calculated between the setpoint coordinates and the geographic coordinates of all the images in the set of images to be browsed. As the images in the set of images are scrolled on screen, the images captured closer to the place where the selected setpoint image was captured are displayed for longer or are displayed in bigger size. Other visual effects or transformations liable to draw the user's attention to the images can be used to highlight the images closer to the setpoint image.

As is apparent from the above description, all the images in the set of images are selected for scroll-through, at least until the user ends the scroll-through if they identify one or more images they are searching for. Users can scroll through images one by one, or page by page, to review a very large number of images. By changing the display parameters, especially image size and display duration, according to a relevant criterion in the way described above, the user can scroll through the image set much faster without narrowing down the chances of visually identifying the image they are looking for.

These chances can be increased further by avoiding a random scroll-through of the images in the set of image selected and instead having an ordered scroll-through sequence.

Thus, according to one improved development of the invention, the images are scrolled on screen one by one in a sequence based on at least one of the indexation values. This sequencing can be made simpler by the fact that the indexation values are taken on a measurement scale. Thus, the images can simply be scrolled on screen in increasing or decreasing order of the indexation values. Considering time-based indexation values, it is therefore possible to display the images from the oldest to the most recent, or vice versa. When there is a setpoint indexation value, the images can be made to scroll on screen in an order where the images whose indexation values are closest to the setpoint value are displayed first.

Images sharing the same indexation value can be displayed together but in random order if the display screen is not big enough to display them simultaneously. This order sequence can be further refined by using several indexation values on several measurement scales.

It is also possible to sequence the order of image display using the function that determines the display parameters. This means, for example, that images scheduled to be displayed biggest or for the longest duration are made to scroll first, or at least one after the other.

According to yet another possibility, each image can comprise a first indexation value according to a first measurement scale and a second indexation value according to a second measurement scale. In this scenario, the images are scrolled through according to an order taken by the first indexation values on the first measurement scale, while the display parameter for each image can be a function of the second indexation value on the second measurement scale.

The first and second scales can be the same or different.

They can also present shared values even though different scales are used. To illustrate this point, a first measurement scale can be a date-based time scale. A second measurement scale can be a period-based time scale. The two scales can use indications of the month as shared values.

Again, as a further illustration, the images, and in particular photographs, can be displayed in a time-based order of image capture and according to display parameters that are a function of the place the image was captured.

Other characteristics and advantages of the invention will appear in the following description, with reference to the figures in the appended drawings. This description is given as an illustration and is not limiting.

### BRIEF DESCRIPTION OF THE DRAWINGS

FIG. 1 is a flowchart showing the main steps of a browsing method according to an embodiment of the invention.

FIG. 2 is a diagrammatic illustration of an image browsing scroll-through possibility according to an embodiment of the invention.

FIG. 3 is a diagrammatic illustration of another image browsing scroll-through possibility according to an embodiment of the invention.

### DETAILED DESCRIPTION OF THE INVENTION

Throughout the following description, the term ‘image’ essentially refers to digital photographs. However, it is understood that the images are not necessarily photographs. They may be any piece of artwork that can be displayed on a screen, regardless of the method used to produce it. Browsing can also be carried out on collections of objects represented by images. These may, for example, be images representing video sequences, such as the first frame in the sequence or a small set of key images that are representative of the sequence, or possibly the cover image of a piece of music in digital format. Furthermore, and to simplify the description, the term ‘image’ is used to cover both digital image data and the image displayed using said data.

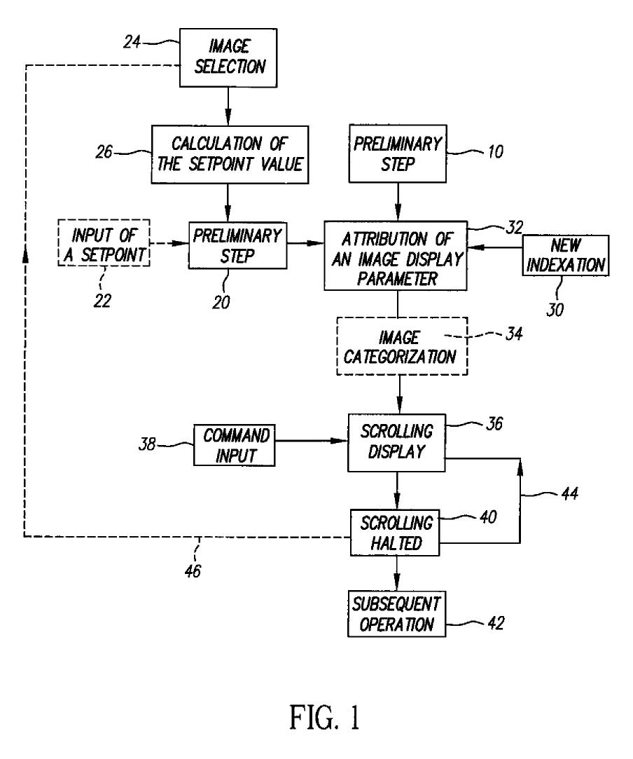

A preliminary step 10 of the browsing method shown in FIG. 1 can consist in selecting a set of images corresponding to a subset of a much larger collection of images. This step is only carried out if the user is first able to eliminate the images that they do not want to scroll through or select a subset of image data from the memory of the browsing means they are employing.

Another preliminary step 20 that is not necessarily part of the browsing but that can make browsing far more effective consists in setting one or more setpoint indexation values. Said setpoint value(s) can be set by inviting the user to enter these values via the alphanumeric interface of the equipment on which the browsing method is proposed. The user can, for example, enter a date or other time-based information, such as a month in the year. The input 22 by the user of a setpoint value is represented by a dashed-line box in FIG. 1. The step can also include the selection of a parameter setting function for displaying the images and a particular order in which they are to be displayed. This function or display order can, for example, be selected from a list of several options that are proposed to the user via their equipment's interactive menu. A parameter setting function can also be automatically selected based on the type of setpoint value chosen. A time-based parameter function or a time deviation function can, for example, be selected in response to the user's choice of a data as setpoint value.

Another possibility for setting a setpoint value consists in inviting the user to select an image beforehand from a scaled-down set of images. This selection step, shown as reference 24, consists in choosing an image that is not the image the user is looking for but which presents similar features to it. These similar features may be time-related, geographical, or calorimetric, or any other parameter feature capable of being expressed on a measurement scale. The selection 24 of an image, which in this description is called a ‘setpoint image’, is followed by the calculation 26 of one or more setpoint indexation values based on this image. The setpoint indexation values thus established can be used in the browsing.

Yet another step that is not, strictly speaking, part of the browsing itself, consists in indexing the images in a selected set of images.

Browsing is generally carried out using pre-indexed images. For example, the image data recorded by digital camera devices generally include the date and time of image capture. The time cue therefore automatically forms part of the image data. The same is true for geographical data when the image capture device is equipped with a geographic localization system. However, it remains possible to carry out a re-indexation of the images 30 at the same time as the browsing method is employed. This may well be the case after a setpoint indexation value has been entered. To illustrate this point, if a setpoint value is a quantity of white in an image, such as when searching for an image taken in a snowy landscape, it may be that the quantity of white in each image of the image set selected is not actually part of the available data. Thus, the calculation of the quantity of white in each image in the selected image set, which is performed for later use as an indexation value, can take place at step 30.

A browsing step 32 consists in attributing each image in the set of images selected with a display parameter. This may be, for example, a display duration, a display size, an enlargement, or a quantity of color used for display. As stated previously, this parameter can be calculated either directly according to an indexation value for each image, or else as a function of a deviation calculated between the indexation value and a corresponding setpoint indexation value.

The function tying the display parameter to the indexation value can be a linear function or a non-linear function. It may, for example, be a function that decreases with the deviation separating the indexation value and the setpoint value. The images can thus be displayed bigger as the deviation between image capture time and setpoint time gets smaller. This function can also be a stepwise function. This function can either be predetermined or left for the user to choose.

An optional step 34 consists in sorting the images in the set of images so that they can be displayed in a particular order. This sorting step may classify the images according to an order dictated by the indexation values, or else according to an order dictated by the deviations between the indexation values and the setpoint value. The orders may be locally or globally increasing or decreasing orders. They can be more or less complex depending on the number of indexation values and measurements scales taken into account for each image. In the same way as for the display parameter setting function, the order can be either pre-determined of left for the user to choose.

Reference 36 highlights an essential step, which is the scrolling image display. The images can be displayed one by one or page by page. They are displayed in a way that may be dependent on previously established display parameters. The non-uniform display of the images means that overall scrolling speed can be increased. Furthermore, by choosing appropriate setpoint values, it becomes possible, despite the faster scroll-through speed, to further improve the user's chances of identifying the image they are looking for.

Reference 38 shows the step where the user inputs a command that can change scroll-through speed and possibly stop the scrolling while the images are being scrolled through on screen. Changing the scrolling speed can have a general influence on individual image display times. This does not affect how display times are modulated as a function of the individual indexation values of the images. The images that are potentially more relevant therefore remain highlighted.

The on-screen scroll-through speed can be entered via a command interface capable of being toggled by the user. This is, for example, either a proportional or a logarithmic interface. Input interface sensitivity can also be continuously modified while the images scroll on screen, depending on the indexation values and the images displayed, respectively.

Step 40 corresponds to stopping the image scrolling following a command input from the user. The user is in fact able to halt the scroll feature when an image they are looking for appears on screen. The image selected thus remains displayed on screen. The scroll stoppage 40 can also be triggered automatically when the indexation value(s) of an image displayed exactly match the setpoint value.

Halting the scroll feature can also comprise freezing the display of the image that was displayed at the time the scroll feature was stopped. It can also comprise the display of several images immediately preceding the scroll stop command.

The user can use the halt in scrolling to select either the image or images thus selected. The user can also launch the subsequent operation 42 which is no longer part of the browsing method. Operation 42 is, for example, an image print-out, or forwarding the image data to a correspondent, or indeed saving the image in another directory.

If the image held at the time the scroll feature was stopped does not fit the user's requirements, then scroll feature 36 can continue to the following images that have not yet been displayed. This possibility is illustrated by arrow 44.

If the image selected is not the image the user was looking for but nevertheless presents very similar features to the image selected as setpoint image during selection step 24, then the image selected by halting the scroll feature can be used as a new setpoint image and the browsing method can be reiterated. This option is shown by dashed-line arrow 46.

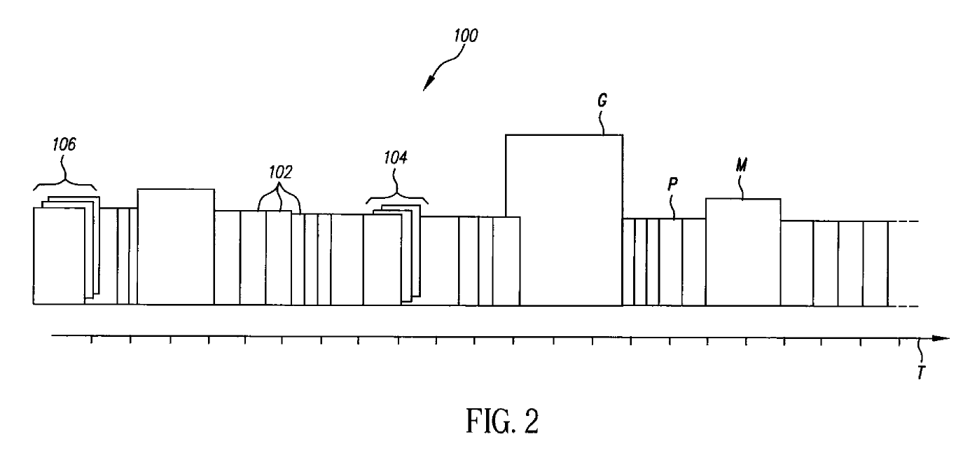

FIG. 2 is a simplistic diagrammatic illustration of an image scroll-through possibility according to the browsing method of FIG. 1.

Arrow T shows time on an open-ended scale. It is used here to illustrate the display order and duration of a certain number of images 102 taken from a set of images 100. The display duration is represented by a more or less significant time difference on the time scale of the boxes showing the images 102 displayed.

In the example given in FIG. 2, the image display size and display duration are functions of an image indexation value. This may, for example, be a value expressing a distance between the place the image was captured and a given geographic location. Image size, or enlargement, can take one of three values P, M or G, according to three range spreads of distances. The display duration is determined according to a function that can be different but that eventually results in a longer display time for the more relevant images, i.e. the images that have the smallest indexation value, which in this case is distance. Consequently, the ‘relevant’ images are displayed bigger and for a longer duration than ‘non-relevant’ images. Furthermore, display time and display size can also be functions of a user command that is independent of the indexation values.

When several images offer identical indexation values, it is possible to build clusters 104 of these images. The scrolling display can then program a longer-lasting display of a single image representing the whole cluster, or else the simultaneous display of all the images in the cluster.

The order that the images appear in while being scrolled through can be a random order or may possibly be an order established according to a measurement scale for indexation values shared by said images. This indexation is, however, different from the indexation whose values determine image display size and duration.

A scrolling display such as that illustrated in FIG. 2 can preferentially display certain images, in particular depending on the user's choices. This provides the option, if necessary, of browsing through all the images in a selected set of images at an overall higher scroll-through speed that would be possible with an undifferentiated display.

However, the overall display duration of an image considered as relevant remains very slow when the overall scroll-through speed selected approaches the upper limits of the user's ability to visually read them.

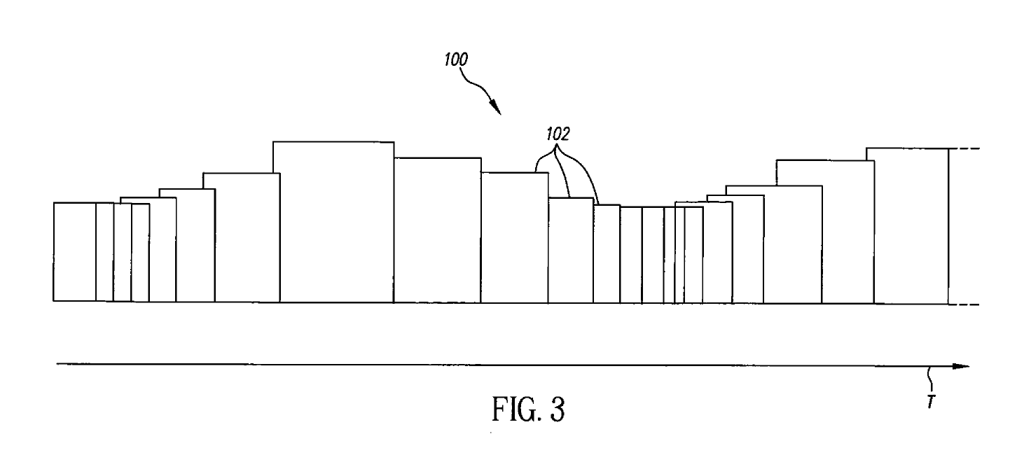

FIG. 3 illustrates another display possibility where the images 102 are allowed to scroll at a speed that is slower, the same, or even slightly faster than the limit of the user's ability to read them.

As in FIG. 2, there is an arrow T that shows a time scale in relation with the image scrolling. However, in contrast with the example illustrated in FIG. 2, the order of on-screen image display is not random.

Prior to being displayed, the images are categorized on a measurement scale into an order that is a function of at least one indexation value that is shared with those used to configure the display parameters. The scrolling display is thus carried out in this order.

FIG. 3 illustrates, for example, a situation where the user is looking for photographs taken on two birthdays. In this scenario, the user selects the day and the month of the birthdays as setpoint values and selects a display parameter function that takes into account the deviation between the day and the month of image capture for each individual image and the setpoint days and months. The year of image capture is not included in this example.

The order of scrolling display is determined according to the date the images (photographs) were captured. The indexation corresponding to the day and the month of image capture is consequently the same for a measurement scale used to configure the display parameters as well as determine the order of image display.

Furthermore, in the example illustrated by FIG. 3, image size is no longer simply spread across a range of three values but is now a linear function of the measured time deviation in relation to the days and months of the birthdays.

Consequently, the end result is an image display that varies in terms of both display size and display duration, in such a way that the images are displayed bigger and for a longer duration as their image capture dates get closer to those selected. Moreover, the fact that the images are ordered according to a time scale means that all the relevant images either side of a date follow in close sequence. Therefore, during the scrolling display, the user sees a kind of slowdown ‘around’ the birthday dates selected.

The invention has been described in detail with particular reference to certain preferred embodiments thereof but it will be understood that variations and modifications can be effected within the spirit and scope of the invention.

1. Method for browsing within a set of images (100) comprising images (102) that have each been indexed with a first indexation value according to a first measurement scale and a second indexation value according to a second measurement scale, the method further comprising a scrolling image display carried out according to an order dictated by the first indexation values on the first measurement scale, wherein at least one display parameter for each image is a non constant function of its second indexation value on the second measurement scale.

2. A method according to claim 1, wherein the display parameter is chosen from among the options of a display duration, a display size, an image saturation, and a display presentation.

3. A method according to claim 1, comprising the selection (20), by the user, of at least one display parameter function.

4. A method according to claim 1, comprising the selection (20) of at least one setpoint value and in which the display parameter of each image is a function of at least one deviation between the image's indexation value and the setpoint value, said deviation being measured on at least one measurement scale common to both the setpoint value and the indexation value.

5. A method according to claim 4, wherein the selection of at least one setpoint value is performed via an input interface.

6. A method according to claim 4, comprising the selection, by the user, of at least one setpoint image, and the use of at least one image indexation value as the set point value.

7. A method according to claim 1, comprising an on-screen image scrolling display in which each image appears in an order sequence based on at least one of its indexation values.

8. A method according to claim 1, wherein the first and second measurement scales share common values.

9. A method according to claim 1, wherein the measurement scale is chosen from among the options of a time scale, a distance scale, a spatial coordinates scale, a data volume scale, a distribution of image texture data scale, a colorimetric scale, a luminosity scale, an image quality scale, a scale defining the number of times the image has been edited, a scale defining the number of images associated with a given image, or a scale defining the number of times the image has been used in photo products.

10. A method according to claim 1, wherein the image display is additionally a function of a display command entered by means of an interface.

11. A method according to claim 10, wherein the sensitivity of the command input interface changes as a function of the image's indexation value.
